(19) United States
(12) Patent Application Publication
(10) Pub. No.: US 2010/0269856 A1
(43) Pub. Date: Oct. 28, 2010

(54) WAFER CLEANING MACHINE AND CLEANING METHOD THEREOF

(75) Inventors: CHIEN HSIN HSU, TAIPEI COUNTY 241 (TW); JEN JUI CHENG, TAIPEI CITY 100 (TW)

Correspondence Address: ROSENBERG, KLEIN & LEE, 3458 ELLICOTT CENTER DRIVE-SUITE 101, ELLICOTT CITY, MD, 21043, US

(73) Assignee: INOTERA MEMORIES, INC., TAOYUAN COUNTY 333 (TW)

(21) Appl. No.: 12/542,202

(22) Filed: Aug. 17, 2009

(30) Foreign Application Priority Data
Apr. 24, 2009 (TW) 98113601

(51) Int. Cl. B08B 7/00

(52) U.S. Cl. 134/6; 134/151

(57) ABSTRACT

The present invention provides a wafer cleaning machine, which includes a machine base, a rotating disk for bearing and driving a wafer, a first nozzle for spraying ion water to the surface of wafer, a brushing module, and a second nozzle. The rotating disk is connected with the machine base. The first nozzle is connected with the machine base and it is above the rotating disk. The brushing module is connected with the machine base and it is above the rotating disk. The second nozzle is connected with the machine base and it is above the rotating disk.

### BACKGROUND OF THE INVENTION

1. Field of the Invention

The present invention relates to a cleaning method and an apparatus for applying such cleaning method, especially for a wafer, notably for a semiconductor wafer and a cleaning machine able to apply such method.

2. Description of Related Art

Referring to FIG. 1, a cleaning mechanism 1a is disclosed. The cleaning mechanism 1a includes a set of brushes 11a, two rollers 12a, and two sets of nozzles 13a. A wafer 2a is assembled between the set of brushes 11a, the two sets of nozzles 13a are under the wafer 2a, and rollers 12a touch the rim of wafer 2a for rotating the wafer 2a.

Referring to FIG. 2, a user firstly assembles the wafer 2a in the wafer cleaning machine 1a (S101a), and then each of the nozzles 13a sprays ion wafer to the surface of wafer 2a (S102a). Dirt adhered on the surface of wafer 2a dissolves in ion water, and then brushes 11a starts brushing the surface of wafer 2a (S103a). After brushes 11a brush the wafer 2a for a period of time, the nozzles 13a and the brushes 11a stop working, and then the rollers 12a rotates to make that ion water 3a is taken out from the surface of wafer 2a, so that the aim of cleaning the wafer 2a is finished (S104a).

Referring to FIG. 3, after the rollers 12a rotate for a period of time, much ion water 3a is still on the surface of wafer 2a and can't be of the surface of wafer 2a entirely, and the ion water 3a makes that the wafer 2a is poor and can not be used for consumers, so that it will waste much cost.

Hence, the inventors of the present invention believe that the shortcomings described above are able to be improved and finally suggest the present invention which is of a reasonable design and is an effective improvement based on deep research and thought.

### SUMMARY OF THE INVENTION

It is an object of the present invention to provide a wafer cleaning machine and a method thereof, ion water on the surface of wafer can be removed entirely, so that yield of manufacturing wafer is raised.

To achieve the above object, the present invention provides a wafer cleaning machine, which includes a machine base, a rotating disk for bearing and driving a wafer, a first nozzle for spraying ion water to the surface of wafer, a brushing module, and a second nozzle. The rotating disk is connected with the machine base. The first nozzle is connected with the machine base and it is above the rotating disk. The brushing module is connected with the machine base and it is above the rotating disk. The second nozzle is connected with the machine base and it is above the rotating disk.

the present invention further provides a cleaning method of the wafer cleaning machine, and the steps of the cleaning method comprises: spraying ion water to a wafer; brushing the surface of wafer; stop spraying ion water and stop brushing the wafer; and spraying gas to the wafer to form a boundary between the ion water and the gas; and rotating the wafer to take out the ion water from the surface of the wafer.

The second nozzle sprays gas to form a boundary between the gas and the ion water on the wafer, and then the rotating disk rotates to expand the boundary toward the rim of the wafer gradually so that ion wafer can be taken out from the surface of the wafer entirely to raise the yield of the wafer, besides wasting cost can be avoided.

### BRIEF DESCRIPTION OF THE DRAWINGS

FIG. 1 is a perspective view of a wafer cleaning machine related to a prior art.

FIG. 2 is a flowchart of a cleaning method of the wafer cleaning machine in FIG. 1.

FIG. 3 is a diagram showing a wafer is cleaned by the cleaning method in FIG. 2.

FIG. 4 is a perspective view of a wafer cleaning machine of this invention.

FIG. 5 is a flowchart of a cleaning method of the wafer cleaning machine in FIG. 4.

FIG. 6 is a diagram showing that a second nozzle sprays nitrogen to form a boundary between nitrogen and ion water of this invention.

FIG. 7 is a diagram showing that a rotating disk rotates to expand a boundary between nitrogen and ion water of this invention.

FIG. 8 is a diagram showing a wafer is cleaned by the cleaning method in FIG. 5.

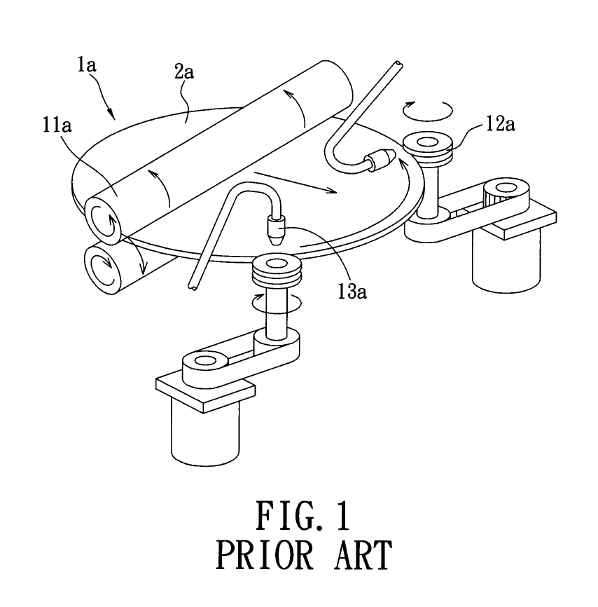

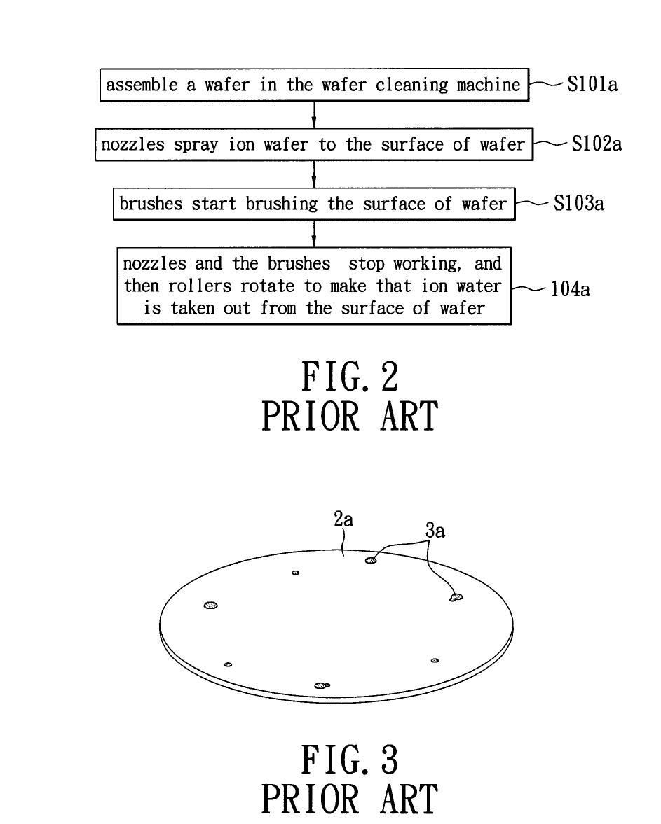

### DETAILED DESCRIPTION OF THE PREFERRED EMBODIMENTS

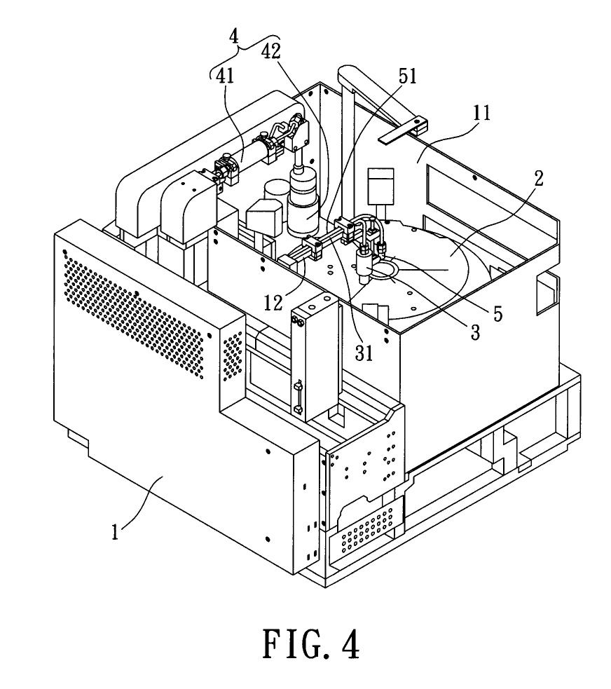

As shown in FIG. 4, this invention provides a wafer cleaning machine, wherein the wafer cleaning machine includes a machine base 1, a circular rotating disk 2, a first nozzle 3, a brushing module 4 and a second nozzle 5. The machine base 1 has a receiving space 11, the rotating disk 2 is mounted in the receiving space 11 and is connected with the machine base 1.

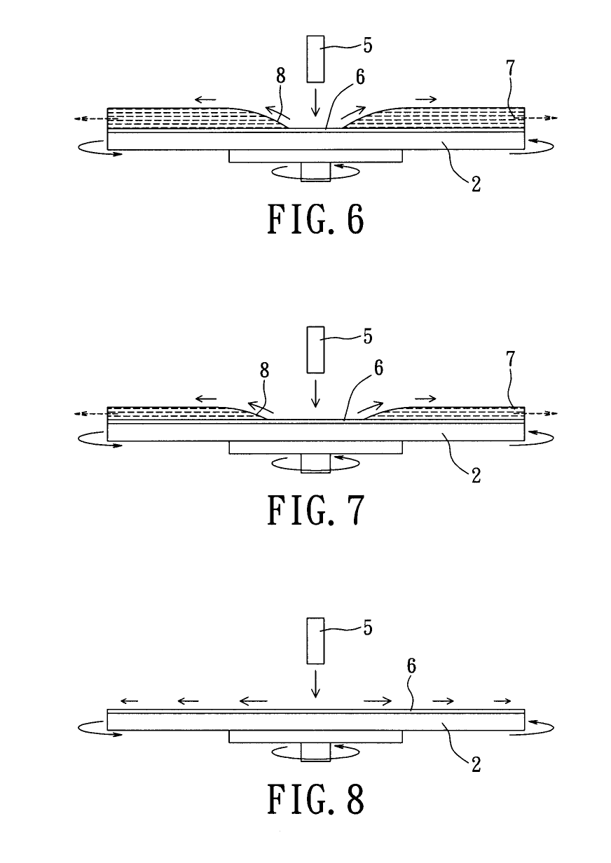

The rotating disk 2 is used to berry and drive a piece of wafer 6 (shown in FIG. 6), the piece of the wafer 6 is fixed with the rotating disk 2, and the center of the piece of the wafer 6 is aimed at the center of the rotating disk 2. Besides, the fastest rotational speed of the rotating disk 2 is 4000 rpm. The machine base 1 has an inside wall received in the receiving space 11, a rail 12 is protruded from the inside wall toward another inside wall which faces to the inside wall.

The first nozzle 3 and the second nozzle 5 connect a first pipe 31 and a second pipe 51 respectively, the first pipe 31 is filled with ion water 7, and the second pipe 51 is filled with nitrogen. Besides, the first pipe 31 and the second pipe 51 are mounted on the top of the rail 12. The rail 12 makes that the first nozzle 3 and the second nozzle 5 is aimed at appropriate regions of the piece of the wafer 6, the first nozzle 3 sprays ion water 7 to the piece of the wafer 6, the second nozzle 5 sprays nitrogen to the surface of the piece of the wafer 6, and the perfect position of the second nozzle 5 is aimed at the center of the rotating disk 2, so that the nitrogen is sprayed to the center of the piece of the wafer 6.

The brushing module 4 includes a movable robot arm 41 and a rotably brush 42, one end of the robot arm 41 is connected with the machine base 1, the brush 42 is connected with another end of the robot arm 41. By the robot arm 41, the brush 42 can brush the piece of the wafer 6 everywhere.

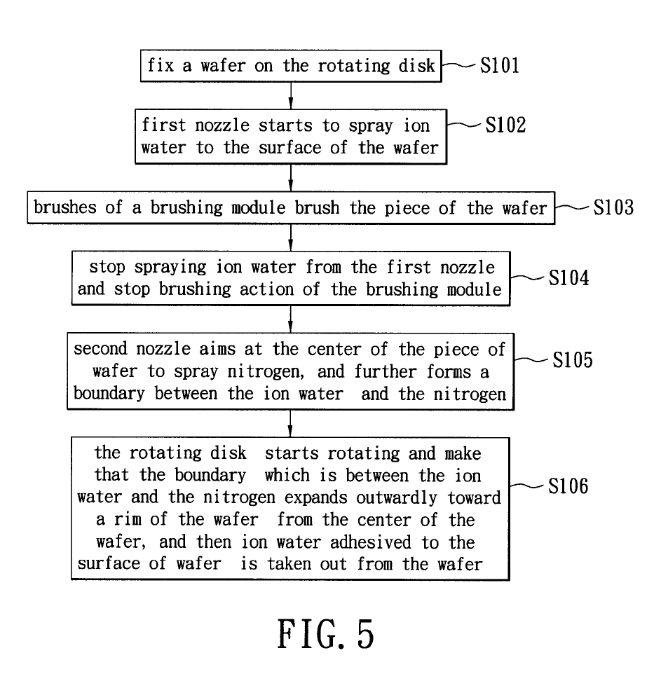

As shown in FIG. 5, this invention further provides a cleaning method of the wafer cleaning machine, the steps of the method is described below.

S101 step: a user fixes the wafer on the rotating disk 2.

S102 step: the first nozzle 3 starts to spray ion water 7 to the surface of the wafer 6 and dirt dissolves in ion water 7.

S103 step: the robot arm 41 of the brushing module 4 moves continuously, the brush 42 which is rotating can brushes the piece of the wafer 6 everywhere.

S104 step After the brush 42 brushes he piece of the wafer 6 for a period of time which the user has set.(normal level is ten to fifteen seconds), stop spraying ion water 7 from the first nozzle 3 and stop brushing action of the brushing module 4.

S105: as shown in FIG. 6, the second nozzle 5 aims at the center of the piece of wafer 6 to spray nitrogen, and further forms a boundary 8 between the ion water 7 and the nitrogen.

S106: as shown in FIG. 7, the rotating disk 2 starts rotating and the rotational speed of the rotating disk 2 is between 3000 rpm˜4000 rpm. Further drives the wafer 6 to rotate with the rotating disk 2 and make that the boundary 8 which is between the ion water 7 and the nitrogen sprayed from the second nozzle 5 gradually expands outwardly toward a rim of the wafer 6 from the center of the wafer 6 and then ion water 7 adhesived to the surface of wafer 6 is taken out from the wafer 6. Finally the aim of cleaning the wafer 6 is arrived.

As shown in FIG. 8, the rotating disk 2 cooperates with the second nozzle 5 to take out the ion water 7 from the wafer 6 entirely, and when the wafer 6 which no ion water 7 is adhesived with the wafer 6 is proceed in the wafer production line, the final wafer product has high probability to be useful for consumers.

The advantages of the wafer cleaning machine and the cleaning method of the wafer cleaning machine are described below:
1. The second nozzle 5 sprays nitrogen to the surface of wafer 6 to form a boundary 8 between the ion water 7 and the nitrogen, and further the second nozzle 5 cooperates with the rotating disk 2 which is rotating, the boundary 8 gradually expands outwardly toward the rim of wafer 6, so that the ion water 7 can be taken out from the wafer 6 entirely. So the yield of wafer 6 is improved, and the manufacturing cost can be avoid wasting.
2. The rotating disk 2 cooperates with the second nozzle 5 to decrease time for cleaning the wafer 6, so that the efficiency of cleaning work is improved.

What are disclosed above are only the specification and the drawings of the preferred embodiment of the present invention and it is therefore not intended that the present invention be limited to the particular embodiment disclosed. It will be understood by those skilled in the art that various equivalent changes may be made depending on the specification and the drawings of the present invention without departing from the scope of the present invention.

What is claimed is:

1. A wafer cleaning machine, comprising:
a machine base;
a rotating disk used to bear and drive a wafer, wherein the rotating disk is connected with the machine base;
a first nozzle used to spray ion water to a surface of the wafer, where in the first nozzle is connected with the machine base and is above the rotating disk;
a brushing module used to brush the surface of the wafer, wherein the brushing module is connected with the machine base and is above the rotating disk; and
a second nozzle used to spraying gas to the surface of the wafer, wherein the second nozzle is connected with the machine base and is above the rotating disk.

2. The wafer cleaning machine as claimed in claim 1, wherein the machine base has a receiving space, the rotating disk is mounted in the receiving space and is connected with the machine base.

3. The wafer cleaning machine as claimed in claim 1, wherein the machine base has an inside wall received in the receiving space, and the inside wall protrudes a rail toward another inside wall which faces the inside wall.

4. The wafer cleaning machine as claimed in claim 3, wherein the rail is above the rotating disk, the first nozzle and the second nozzle are connected with a bottom of the rail slidably.

5. The wafer cleaning machine as claimed in claim 3, wherein the first nozzle is connected with a first pipe, the second nozzle is connected with a second pipe, the first pipe and the second pipe are mounted on a top of the rail.

6. The wafer cleaning machine as claimed in claim 1, wherein the gas is nitrogen.

7. The wafer cleaning machine as claimed in claim 1, wherein the brushing module includes a robot arm and a brush, one end of the robot arm is connected with the machine base, and the brush is connected with another end of the robot arm.

8. The wafer cleaning machine as claimed in claim 1, wherein the second nozzle is aimed at a center of the rotating disk.

9. The wafer cleaning machine as claimed in claim 1, wherein the fastest rotational speed of the rotating disk is 4000 rpm.

10. A cleaning method of a wafer cleaning machine, comprising:
spraying ion water on a wafer;
brushing a surface of the wafer;
stop spraying ion water and stop brushing the wafer;
spraying gas to the wafer to form a boundary between the gas and the ion water; and
rotating the wafer to take out the ion water from the wafer.

11. The cleaning method as claimed in claim 10, wherein the gas is sprayed to a center of the wafer.

12. The cleaning method as claimed in claim 11, wherein the boundary gradually expands outwardly toward a rim of the wafer from the center of the wafer.

13. The cleaning method as claimed in claim 10, wherein the gas is nitrogen.

14. The cleaning method as claimed in claim 10, wherein the rotational speed of the rotating disk is between 3000 rpm˜4000 rpm.

15. The cleaning method as claimed in claim 10, wherein the wafer is brushed for ten to fifteen seconds.
